(19) United States
(12) Patent Application Publication
(10) Pub. No.: US 2014/0115055 A1
(43) Pub. Date: Apr. 24, 2014

(54) Co-relating Visual Content with Geo-location Data

(71) Applicant: Dean Kenneth Jackson, Pittsburgh, PA (US)

(72) Inventor: Dean Kenneth Jackson, Pittsburgh, PA (US)

(21) Appl. No.: 13/658,193

(22) Filed: Oct. 23, 2012

(51) Int. Cl. G06F 15/16

(52) U.S. Cl. 709/204

(57) ABSTRACT

The present disclosure comprises systems and methods for determining and co-relating geo-location information or data with visual content, for example one or more photographs in a stream of visual media, when a user captures the visual content to share it with others, either for personal or business purposes (for example, with friends to accompany a review or rating of a particular business, or the like). The systems and methods upon determining that visual content is captured, determine the location of the mobile device used to capture the visual content, map the location using geo-location-mapping resources, and co-relate the location data with the visual content before transmitting the visual content as directed by the user.

### BACKGROUND

The present disclosure relates to providing visual content from mobile telephones to online communities or networks, for example, social or other networks. In particular, the present disclosure relates to technology for enabling users of networks to provide visual content (for example, one or more photographs) of a particular location of interest, from their mobile telephones and co-relate it to location and other data relating to the particular location of interest.

Over the last decade, sharing media over social networks has become increasingly popular. For example, social network users post images, videos, and other media to share the media with others. Moreover, many networks or online communities are dedicated to providing information and reviews to the public on locations of interest, for example, restaurants, hotels, etc. Furthermore, in some instances, these networks or online communities often rate locations of interest to the public. Yet, these reviews and ratings are seldom accompanied by photographs to enable people interested in visiting these locations to view pictures to determine the ambience etc. In some instances, patrons of restaurants may take a picture of the restaurant, if appealing or not, to convey it to their friends or provide the picture for public viewing. Sometimes, people capture the moment, a beautiful site, a delicious meal, or whatever, with their mobile devices and send photographs to another.

### SUMMARY

In one innovative aspect, the present disclosure of the technology includes a system, comprising a processor and a memory storing instructions that, when executed, cause the system to: receive captured visual content via a mobile device by a user from a remote location; determine a location of the mobile device via which the user captures the visual content; map the location, to determine geo-location data for the location; co-relate the geo-location data with the visual content; and transmit the geo-location data with the visual content, to another electronic device.

In general, another innovative aspect of the present disclosure includes a method, using one or more computing devices, for receiving visual content captured via a mobile device by a user from a remote location; determining a location of the mobile device via which the user captured the visual content; mapping the location, to determine geo-location data for the location; co-relating the geo-location data with the visual content; and transmitting the geo-location data with the visual content, to another electronic device.

Other implementations of one or more of these aspects include corresponding systems, apparatus, and computer programs, configured to perform the action of the methods, encoded on computer storage devices.

These and other implementations may each optionally include one or more of the following features.

For instance, the operations further include one or more of: adding a user review of the location to the visual content; adding a rating of the location to the visual content, adding a web link of the location to the visual content; and adding metadata relating to the location to the visual content.

For instance, the features include: the visual content includes an image; the visual content includes a video; the visual content includes an audio recording; and the visual content includes a text description.

The systems and methods disclosed below are advantageous in a number of respects. With the ongoing trends and growth in online social reviews of locations providing goods and/or services, it would be certainly be beneficial to improve upon these online social reviews. The systems and methods allow a user to add additional content (e.g., video, images, audio, etc.) along with the online review to better support the review of the location.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a high-level block diagram illustrating some embodiments of example systems for enabling users to provide visual content from their mobile devices and co-relate it with location and other indications.

FIG. 2A is a block diagram illustrating the hardware components in some example embodiments of the systems shown in FIG. 1.

FIG. 2B is a block diagram illustrating a location-based application of the systems for providing geo-location information on the location indicated by users.

FIG. 3 is a graphical representation of examples of users providing visual content from their mobile devices from remote locations with indications of location and other data with the systems automatically providing geo-location or other data relating to the visual content or the location captured by the visual content.

FIG. 4 is a flow chart of an example general method for receiving a photograph from a user and the system providing related data to the location and receiving other indications by the user to accompany the visual content.

FIG. 5 is a flow chart of an example general method for receiving visual content from a user and receiving further user input to process the data.

FIG. 6 is a flow chart illustrating an example method for capturing visual content and location data at the user device.

FIG. 7 is a flow chart illustrating an example method for receiving a file with visual content and providing information (for example, “hints”) relating to the location.

FIG. 8 is a flow chart illustrating an example method for searching a geo-location-mapping server using a determined location for a photograph and providing “hints”.

FIG. 9 is a graphical representation of the data storage with components of example data.

FIG. 10a is a graphical representation of an example user interface illustrating a display of visual content (for example, a photograph) co-related with location and other data including a map, review etc.

FIG. 10b is a graphical representation of an example user interface illustrating a display of visual content (for example, a photograph) co-related with location and other data including options enabling a user to send a select image with a review etc.

### DETAILED DESCRIPTION

In some embodiments, this technology comprises systems and methods for enabling users of one or more networks to provide visual content (for example, a stream of visual content including one or more photographs, images etc.) from their mobile telephones, and share them with others, via online communities, for example, websites (dedicated or other) for providing information to the public or social networks etc. The systems and methods receive visual content relating to a particular location or interest (for example, a restaurant, hotel, etc.) that is provided by users from their mobile devices, with other indications relating to the particular location or interest. The other indications provided by the user may include a link to the particular location or interest, a review, etc. The systems and methods are configured to co-relate the visual content to the location (for example, by determining geo-location data) and share that with other users or websites for access to the public seeking information on particular locations.

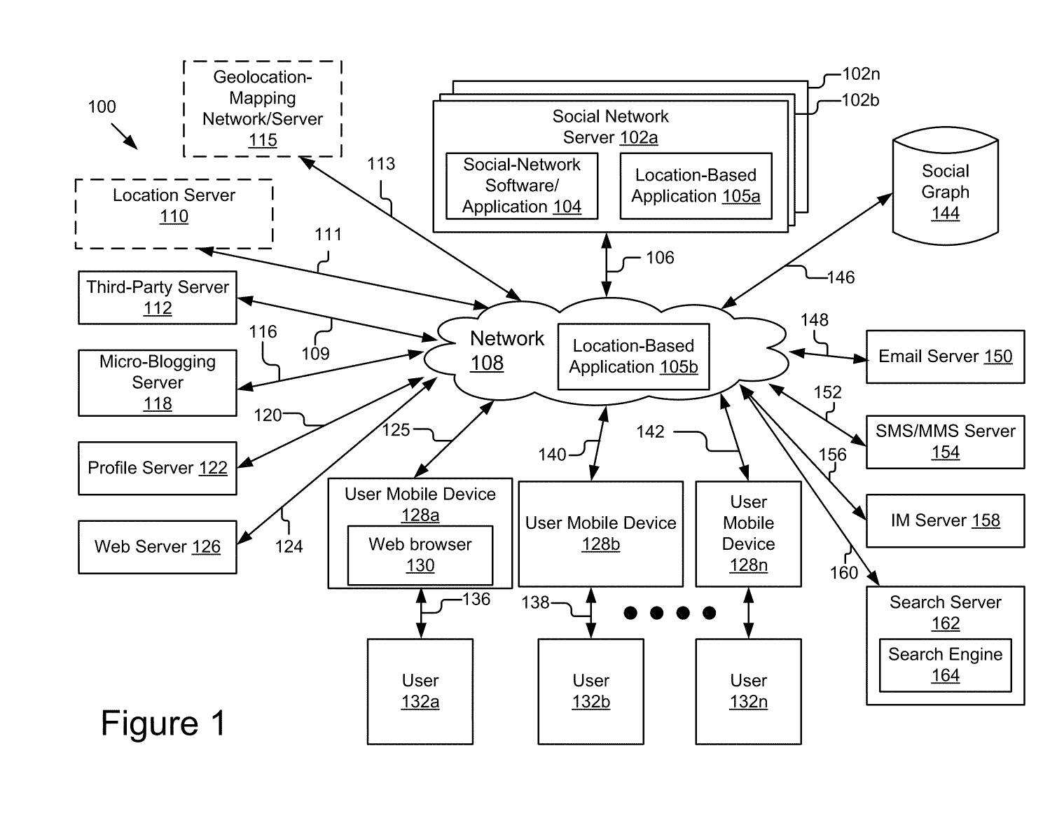

FIG. 1 is a high-level block diagram illustrating some example embodiments of systems for automatically generating and providing location (geo-location) information or data for visual content captured and sent by users from their mobile devices. The system 100 illustrated in FIG. 1 provides system architecture for providing location information and/or other data (for example, reviews etc.) relating to the visual content. The system 100 includes one or more social network servers 102a, 102b, through 102n, that may be accessed via user devices 128a (with web browser 130), 128b, through 128n. The user device 128a is illustrated as connected to the network via a signal line 125, enabling communication flow along that line. The user device 128b is connected to the network 108, via a signal line 140, to enable flow of communication along that line. The user device 128n is connected to the network 108, via a signal line 142, indicating communication flow along that line. Users 132a, 132b, through 132n, may capture visual content (photographs etc.) via their user devices and share them with others, via any one of the social network servers 102a, 102b, through 102n, third party server 112 (hosting websites for public or other access), or any of the other servers illustrated in FIG. 1 (for example, micro-blogging server 118, email server 150, SMS/MMS Server 154 etc.). Although only three user devices 128a, 128b, through 128n are illustrated, it should be recognized that any numbers of user devices 128n may be used by any number of users 132n. In addition, although only one of the user devices is illustrated with a web browser 130, any or all of the other user devices 128b through 128n may also have a web browser 130.

Moreover, it should be recognized that while the present disclosure is described below primarily in the context of receiving visual content captured by users from their mobile devices and providing geo-location data or “hints” relating to the visual content, the present disclosure may be applicable to other media beside visual media, including, but not limited to, audio streams, text streams, etc. For ease of understanding and brevity, the present disclosure is described in reference to providing geo-location and other “hints” with visual content in media streams sent by users from their mobile devices.

The user devices mobile devices 128a through 128n in FIG. 1 are illustrated by way of example. Although FIG. 1 illustrates only three devices, the present disclosure applies to any system architecture having one or more user devices 128n, therefore, any number of user devices 128n may be used. Furthermore, while only one network 108 is illustrated as coupled to the user devices 128a through 128n, the social network servers, 102a-102n, the profile server 122 (with user profiles), the web server 126, and a third-party server 112, in practice, any number of networks 108 may be connected to these entities. In addition, although only one third-party server 112 is shown, the system 100 may include any number of third-party servers 112 that may host websites or online communities for providing and sharing information.

In some embodiments, the social network server 102a is coupled to the network 108 via a signal line 106. The social network server 102a includes a social network application 104, which comprises the software routines and instructions to operate the social network server 102a and its functions and operations. Although only one social network server 102a is described here, persons of ordinary skill in the art should recognize that multiple servers may be present, as illustrated by social network servers 102b through 102n, each with functionality similar to social network server 102a or different.

The term “social network” as used here encompasses its plain and ordinary meaning including, but not limited to, any type of social structure where the users are connected by a common feature or link. The common feature includes relationships/connections, e.g., friendship, family, work, a similar interest, etc. The common features are provided by one or more social networking systems, such as those included in the system 100, including explicitly-defined relationships and relationships implied by social connections with other online users, where the relationships form the social graph 144.

The term “social graph” as used here encompasses its plain and ordinary meaning including, but not limited to, a set of online relationships between users, such as provided by one or more social networking systems, such as the social network system 100, including explicitly-defined relationships and relationships implied by social connections with other online users, where the relationships form a social graph 144. In some examples, the social graph 144 (coupled to the network 108 via signal line 146) may reflect a mapping of these users and how they are related or connected.

It should be understood that the social network server 102a and the social network application 104 are representative of a single social network. Each of the plurality of social network servers 102a, 102b through 102n, is coupled to the network 108, each having its own server, application, and social graph. For example, a first social network hosted on a social network server 102a may be directed to business networking, a second on a social network server 102b directed to or centered on academics, a third on a social network server 102c (not separately shown) directed to local business, a fourth on a social network server 102d (not separately shown) directed to dating, and yet others on social network server (102n) directed to other general interests or perhaps a specific focus.

A profile server 122 is illustrated as a stand-alone server in FIG. 1 coupled to the network 108 via signal line 120. In other embodiments of the system 100, all or part of the profile server 122 may be part of the social network server 102a. The profile server 122 is connected to the network 108 via a line 131. The profile server 122 has profiles for all the users that belong to a particular social network 102a-102n. One or more third-party servers 112 are connected to the network 108, via signal line 109. A web server 126 is connected, via line 124, to the network 108. Other servers for providing or receiving communications from users include micro-blogging server 118, connected to the network 108, via line 116, email server 150 connected to the network 108, via line 148, an sms/mms server 154 connected to the network 108, via line 152, IM server 158, connected to the network 108, via signal line 156, and a search server 162 with a search engine 164, connected to the network 108, via line 160.

The social network server 102a further includes a location-based application, to which user mobile devices 128a, 128b through 128n are coupled via the network 108. In particular, user device 128a is coupled, via line 127, to the network 108. The user 132a accesses, any of the servers, via the user device 128a to interact with them as desired. Persons of ordinary skill in the art should recognize that the location-based application 105a or certain components of it may be stored in a distributed architecture in any of the social network server 102a-102n, a separate location server 110 via signal line 111, the network 108 etc.

The user mobile devices 128a through 128n may be a computing device, for example, a laptop computer, a portable desktop computer, a tablet computer, a mobile telephone, a personal digital assistant (PDA), a mobile email device, a portable game player, a portable music player, a mobile television with one or more processors embedded in the television or coupled to it, or any other electronic device capable of accessing a network.

The network 108 is of conventional type, wired or wireless, and may have any number of configurations such as a star configuration, token ring configuration, or other configurations known to those skilled in the art. Furthermore, the network 108 may comprise a local area network (LAN), a wide area network (WAN, e.g., the Internet), and/or any other interconnected data path across which one or more devices may communicate.

In other embodiments, the network 108 may be a peer-to-peer network. The network 108 may also be coupled to or include portions of one or more telecommunications networks for sending data in a variety of different communication protocols.

In yet other embodiments, the network 108 includes Bluetooth communication networks or a cellular communications network for sending and receiving data such as via short messaging service (SMS), multimedia messaging service (MMS), hypertext transfer protocol (HTTP), direct data connection, WAP, email, etc.

In some embodiments, the social network servers, 102a-102n, the profile server 122, the web server 126, and the third-party server 112 are hardware servers including a processor, memory, and network communication capabilities. One or more of the users 132a through 132n access any of the social network servers 102a through 102n, or other servers, via browsers in their user devices and via the web server 126. User input is illustrated by lines 136 and 138. It should be recognized that any data or information may only be retrieved after receiving permission from the one or more users to protect user privacy and consider user preferences to the extent they are indicated.

As one example, in some embodiments of the system, information on particular users (132a through 132n) of a social network 102a through 102n may be retrieved from the social graph 144.

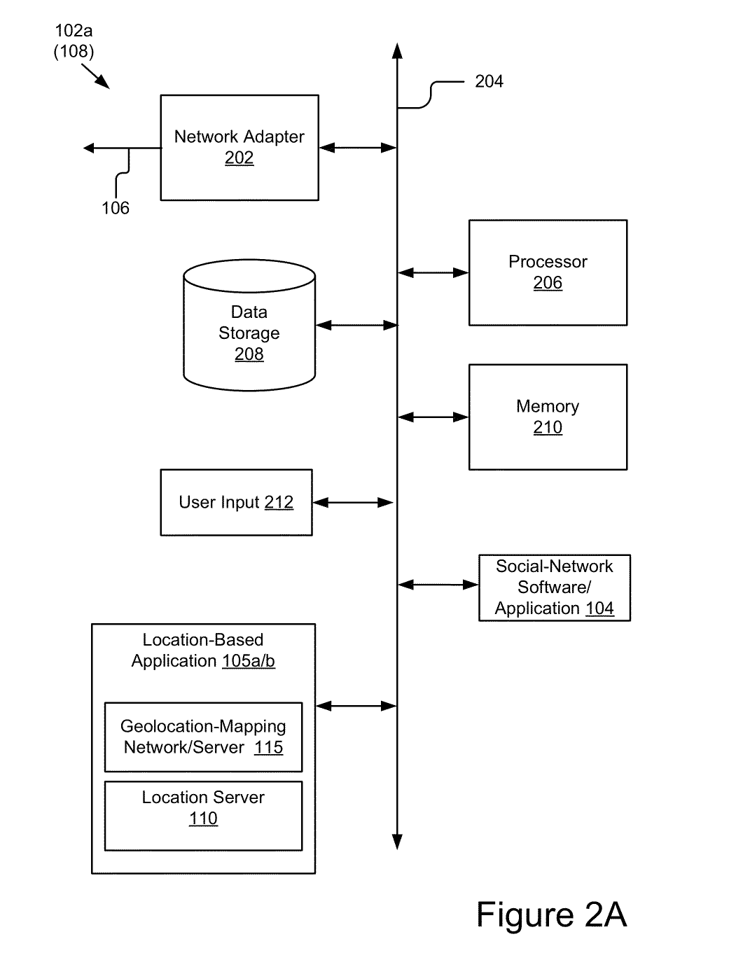

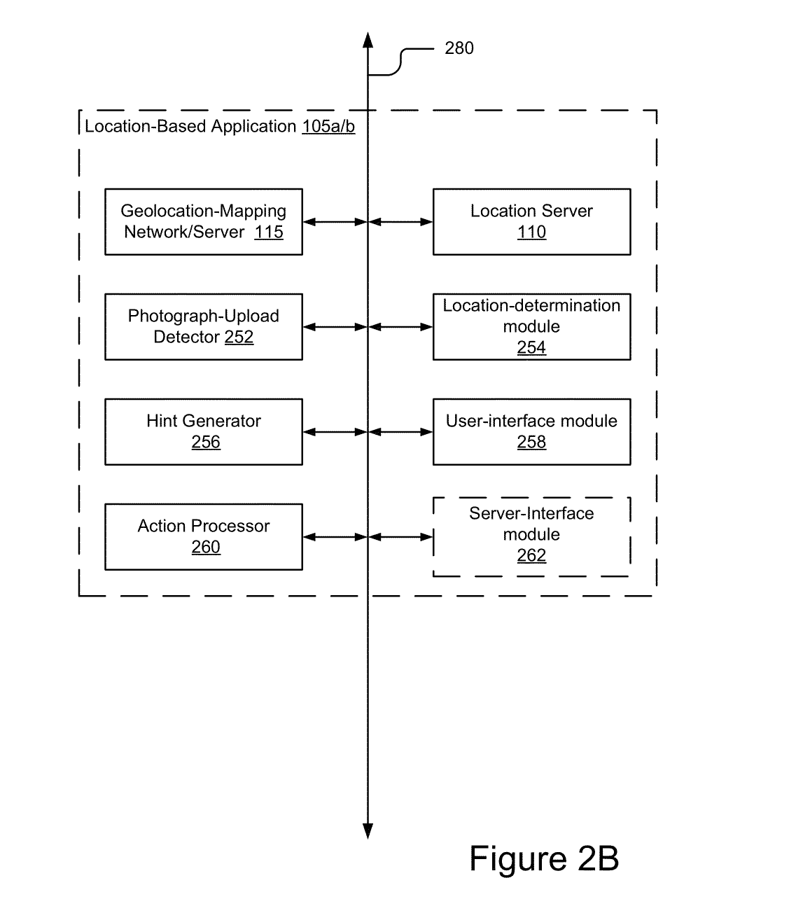

FIG. 2A is a block diagram illustrating some embodiments of the hardware architecture of the social network server 102a including the location-based application 105a/105b. As illustrated in FIG. 1, the location-based application may be located in the social network server 102a or in some instances in the network 108 or in a third party server. In FIG. 2A, like reference numerals have been used to reference like components with the same or similar functionality that has been described above with reference to FIG. 1. As those components have been described above that description is not repeated here. The social network server 102a generally comprises one or more processors, although only one processor 206 is illustrated in FIG. 2A. The processor 206 is coupled, via a bus 204, to memory 210 and data storage 208, which stores information obtained from users or received from any of the other sources identified above. In some embodiments, location-based application 105a/105b may be stored in the memory 210. The location-based application 105a/105b includes the geo-location-mapping network/server 115 connected to the network 108 via signal line 113 (also shown in FIG. 1 in broken lines) and location server 110 (also shown in FIG. 1 in broken lines). These components may be provided by an integrated architecture or distributed.

It should be noted that any information that may be retrieved for particular users to forward visual content is only upon obtaining the necessary permissions from the users, in order to protect user privacy and sensitive information of the users.

A user 132a, via a user device 128a, may capture visual content of interest to the user 132a at a location with the intention of sharing the visual content with others (for example, online communities providing information to the public, family, friends, acquaintances, business associates, etc.). The user 132a may decide to share this visual content, for example, a photograph of a beautiful ambience in a restaurant or a food item that is elegantly presented with others (for example, an online community providing information to the public or a friend). The user 132a may send or forward this visual content from his or her user mobile device (128a through 128n), via user input 212, to a designated party (for example, an online community providing information to the public a friend), via the social networks 102a through 102n, email server 150, sms/mms server 154, IM server 158, or micro-blogging server 118. The user device 128 communicates with the social network server 102a using the network adapter 202, via signal line 106.

The processor 206 processes data signals and program instructions received from the memory 210 and the data storage 208. The processor 206 may comprise various computing architectures including a complex instruction set computer (CISC) architecture, a reduced instruction set computer (RISC) architecture, or an architecture implementing a combination of instruction sets.

The memory 210 may be non-transitory storage medium. The memory 210 stores the instructions and/or data for the location-based application 105, which may be executed by the processor 206. In some embodiments, the instructions and/or data stored on the memory 210 comprises code for performing any and/or all of the techniques described herein. The memory 210 is a dynamic random access memory (DRAM) device, a static random access memory (SRAM) device, flash memory or some other memory device known in the art.

The data storage 208 stores the data and program instructions that may be executed by the processor 206. In some embodiments, the data storage 208 includes a variety of non-volatile memory permanent storage device and media such as a hard disk drive, a floppy disk drive, a CD-ROM device, a DVD-ROM device, a DVD-RAM device, a DVD-RW device, a flash memory device, or some other non-volatile storage device known in the art. A network adapter 202 provides the connection 106 to the network and the social-network software/application 104 is also coupled to the bus 204.

Referring now to FIG. 2B, like reference numerals have been used to reference like components with the same or similar functionality that has been described above with reference to FIGS. 1 and 2A. Since those components have been described above that description is not repeated here. FIG. 2B illustrates one embodiment of the location-based application 105a/b. The location-based application 105a/b includes various applications or engines that are programmed to perform the functionalities described here. The location-based application 105 for providing geo-location information (including “hints”) with visual content to others may include various modules or engines. In some implementations the location-based application includes: the geo-location-mapping network/server 115, the location server 110, a photograph-upload detector 252, a location-determination module 254, a hint generator 256, a user-interface module 258, an action processor 260, and a server-interface module 262.

The geo-location-mapping network/server 115 may be stand-alone and configured for access by other servers. The geo-location-mapping network/server 115 may map a location of a user's mobile device (any of user mobile devices 128a through 128n shown in FIG. 1). The geo-location-mapping/server 115 may be software including routines for mapping locations (latitude or longitude). In some implementations, the geo-location-mapping/server 115 can be a set of instructions executable by the processor 206 to provide the functionality described below for mapping locations. In other implementations, the geo-location-mapping/server 115 can be stored in the memory 210 of the social network server 102 and/or the third-party server 112 and can be accessible and executable by the processor 206. In either implementation, the geo-location-mapping/server 115 can be adapted for cooperation and communication with the processor 206, the user input 212, data storage 208 and other components of any of the servers including the social network server 102 and/or the third-party server 112 via the bus 204.

The geo-location-mapping network/server 115 works in conjunction with the location server 110, which is configured to provide the location information or data where the mobile device is currently located. The location server 110 may be software including routines for providing location data including location coordinates. In some implementations, the location server 110 can be a set of instructions executable by the processor 206 to provide the functionality described below for mapping locations. In some implementations, the location server 110 can be stored in the memory 210 of the social network server 102 and/or the third-party server 112 and can be accessible and executable by the processor 206. In either implementation, the location server 110 can be adapted for cooperation and communication with the processor 206, the user input 212, data storage 208 and other components of any of the servers including the social network server 102 and/or the third-party server 112 via the bus 204.

The photograph-upload detector 252 may be software including routines for uploading visual content, for example, either one or a stream of photographs. In some implementations, the photograph-upload detector 252 can be a set of instructions executable by the processor 206 to provide the functionality described below for uploading visual content. In some implementations, the photograph-upload detector 252 can be stored in the memory 210 of the social network server 102 and/or the third-party server 112 and can be accessible and executable by the processor 206. In either implementation, the photograph-upload detector 252 can be adapted for cooperation and communication with the processor 206, the user input 212, data storage 208 and other components of the social network server 102 and/or the third-party server 112, or other servers via the bus 204.

The location-determination module 254 may be software including routines for determining matching a location to particular visual content (for example, a photograph). In some implementations, the location-determination module 254 can be a set of instructions executable by the processor 206 to provide the functionality described below for determining location coordinates. In some implementations, the location-determination module 254 can be stored in the memory 210 of the social network server 102 and/or the third-party server 112 and can be accessible and executable by the processor 206. In either implementation, the location-determination module 254 can be adapted for cooperation and communication with the processor 206, the user input 212, data storage 208 and other components of the social network server 102 and/or the third-party server 112, or other servers via the bus 204.

The hint generator 256 may be software including routines for determining “hints” relating to possible locations at which a user captured visual content. This is in the instance that a user captures visual content to indicate a particular location or establishment of interest and provides a link to it. The hint generator 256 is configured to view the data at the link and search for possible locations that match the particular establishment of interest. In some implementations, the hint generator 256 can be a set of instructions executable by the processor 206 to provide the functionality described below for determining “hints” relating to locations from where users convey visual content or the like. In some implementations, the hint generator 256 can be stored in the memory 210 of the social network server 102 and/or the third-party server 112 and can be accessible and executable by the processor 206. In either implementation, the hint generator 256 can be adapted for cooperation and communication with the processor 206, the user input 212, data storage 208 and other components of the social network server 102 and/or the third-party server 112, or other servers via the bus 204.

The user-interface module 258, via which visual content is received from user mobile devices may be software including routines for conveying flow of communications or content. In some implementations the user-interface module 258 can be a set of instructions executable by the processor 206 to provide the functionality described below for conveying communications and visual content. In some implementations, the user-interface module 258 can be stored in the memory 210 of the social network server 102 and/or the third-party server 112 and can be accessible and executable by the processor 206. In either implementation, the user-interface module 258 can be adapted for cooperation and communication with the processor 206, the user input 212, data storage 208 and other components of the social network server 102 and/or the third-party server 112, or other servers via the bus 204.

The action processor 260 may be software including routines for determining and processing user actions. As one example, a user may take a photograph of a particular establishment via his or her mobile device and send it to others. As another example a user may activate a link to a location of the particular establishment. As yet another example, a user may share the photograph with others, via his mobile device or via an online community that he or she may access via the web browser 130 on his or her mobile. As yet another example, a user may add a review on the establishment or rate the establishment and provide that input to others. It should be recognized that one or more of these examples may be performed and conveyed together for the photograph. In some implementations, the action processor 260 can be a set of instructions executable by the processor 206 to provide the functionality described below for determining and processing user actions relating to the user content. In other implementations, the location-determination module 254 can be stored in the memory 210 of the social network server 102 and/or the third-party server 112 and can be accessible and executable by the processor 206. In either implementation, the location-determination module 254 can be adapted for cooperation and communication with the processor 206, the user input 212, data storage 208 and other components of the social network server 102 and/or the third-party server 112, or other servers via the bus 204.

In some implementations, the action processor 260 receives one or more actions from the user and processes the action. For example, the action processor 260 receives and image and a location review from a user.

In some implementations, a user provides a rating for the location (e.g., restaurants and other establishments) and media (e.g., image, video, audio recording, text description, etc.). For example, a user may provide a review (e.g., description of the quality of goods and/or service) and a rating (e.g., 4 out of 5 stars) including photograph evidence to support the rating. For example, a restaurant can be rated high and/or expensive; therefore, the picture may show great décor, ambiance, delicious food, etc.

In some implementations, the image may be provided to the one or more servers/networks described above including one or more, links to the location of interest, metadata including the GPS location of the location of interest, etc.

The server-interface module 262 may be software including routines for coordinating communications with other servers in the distributed architecture. In some implementations, the server-interface module 262 can be a set of instructions executable by the processor 206 to provide the functionality described below for coordinating communications with other servers. In other implementations, the server-interface module 262 can be stored in the memory 210 of the social network server 102 and/or the third-party server 112 and can be accessible and executable by the processor 206. In either implementation, the server-interface module 262 can be adapted for cooperation and communication with the processor 206, the user input 212, data storage 208 and other components of the social network server 102 and/or the third-party server 112, or other servers via the bus 204.

In some implementations, the server-interface module 262 coordinates communications with one or more servers. For example, the user captures and image and the server-interface module 262 sends the image to one or more of a social network 102, location server 110, geo-location-mapping network/server 115, etc. In some implementations, the server-interface module 262 sends data between the one or more severs described above.

Software communication mechanism 280 may be an object bus (such as CORBA), direct socket communication (such as TCP/IP sockets) among software modules, remote procedure calls, UDP broadcasts and receipts, HTTP connections, function or procedure calls, etc. Further, any or all of the communication could be secure (SSH, HTTPS, etc.). The software communication can be implemented on any underlying hardware, such as a network, the Internet, a bus 204 (FIG. 2A), a combination thereof, etc.

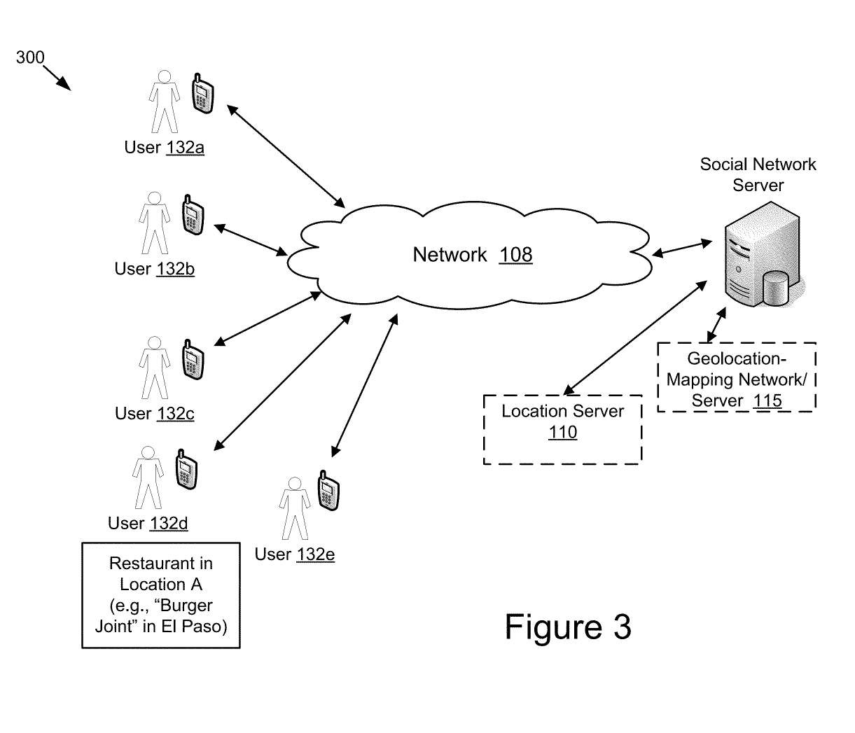

FIG. 3 is a graphical representation illustrating that various users 132a, 132b, 132c, and 132d may be distributed in remote locations, for example, user 132d is located in a restaurant, for example, in this instance, the “Burger Joint,” located in location A, for example, El Paso. Any one or all of the users, for example, 132a, 132b, 132c, 132d, and 132e may capture visual content, for example, photographs, on their user their mobile devices to and transmit them via the network 108 for sharing (by viewing or display other mobile devices or other electronic devices) of others. The location server 110 and the geo-location-mapping network/server 115 concurrently sends location coordinates with the visual content.

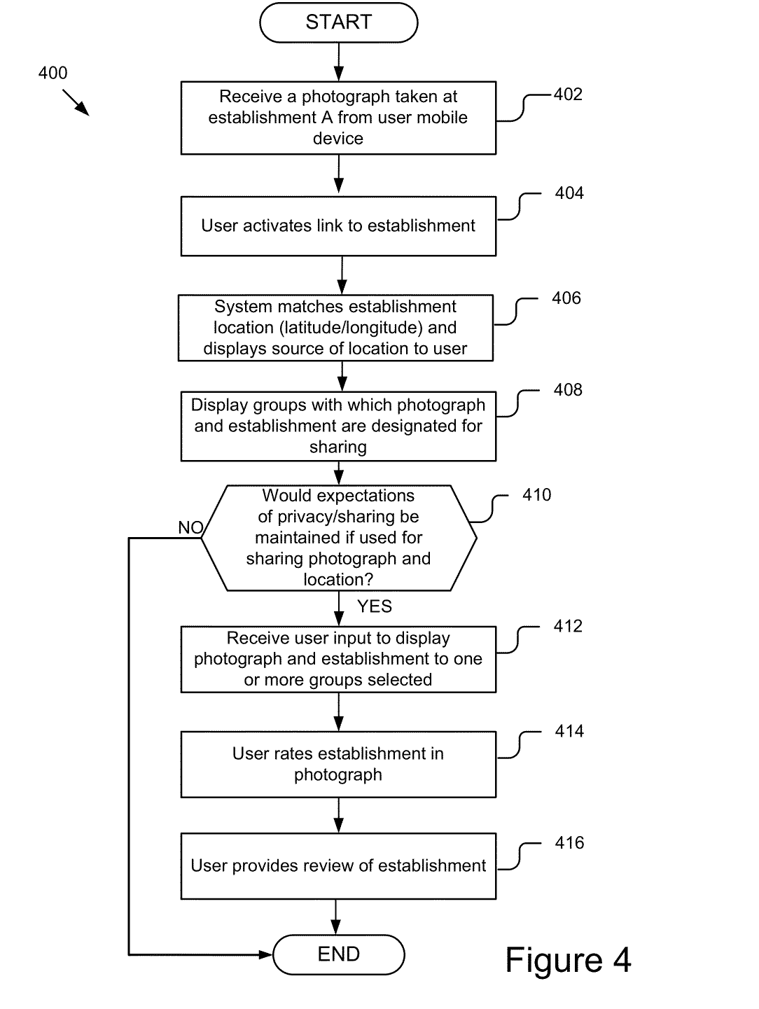

FIG. 4 is a flow chart illustrating an example of a method 400 for receiving user input for a location review. It should be understood that the order of the operations in FIG. 4 is merely by way of example and may be performed in different orders than those that are illustrated and some operations may be excluded, and different combinations of the operations may be performed. The method 400 starts and proceeds to the block 402, at which stage, the photograph-upload detector 252 includes one or more operations for receiving a photograph taken at establishment A (“El Paso”) from user mobile device. The method 400 proceeds to the block 404, at which stage, the user activates a link to the establishment (via the internet). The method 400 proceeds to the block 406, at which stage, the system includes one or more operations for matching the establishment location (latitude/longitude of where “El Paso” is located) and displaying the source of location to the user (for example, a web-mapping network or service).

The method 400 proceeds to the block 408, at which stage, the user-interface module 258 display groups with which photograph and establishment are designated for sharing. The method 400 proceeds to the block 410, at which stage, the system determines if expectations of privacy/sharing would be maintained if used for sharing photograph and location. If privacy expectations are met, the method 400 proceeds to block 412, at which stage, the user-interface module 258 includes one or more operations for receiving user input requesting transmission and display of the photograph and the establishment to one or more groups selected. The method 400 proceeds to the block 414, at which stage, a user may decide to rate the particular establishment in photograph. The method 400 proceeds to the block 416, at which stage, the user may elect to provide a review of the establishment.

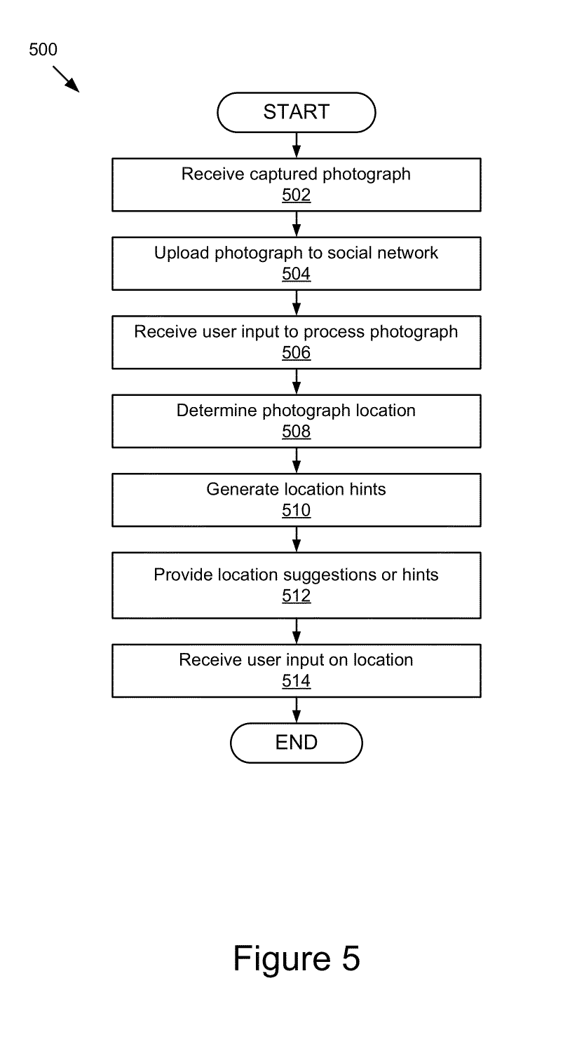

FIG. 5 is a flow chart illustrating an example of a method 500 for identifying places (for example, locations of establishments and places near a user). It should be understood that the order of the operations in FIG. 5 is merely by way of example and may be performed in different orders than those that are illustrated and some operations may be excluded, and different combinations of the operations may be performed. The method 500 starts and proceeds to the block 502, at which stage, the location-determination module 254 receives a photograph of an establishment captured by a user at the establishment. The method 500 proceeds to block 504, at which stage, the photograph-upload detector 252 uploads the photograph to a social network. The method 500 proceeds to block 506, at which stage, the user-interface module 258 receives user input to process the photograph.

The method 500 continues to block 508, at which stage, the location-determination module 254 determines the location of the establishment in the photograph. The location-determination module 254, may receive a link to the establishment provided by the user, and may read EXIF (exchangeable image file format) data from the photograph, which has encoded the time and location of where the photograph was taken. The method 500 proceeds to block 510, at which stage, the hint generator 256 generates location “hints”. With this location information, the user is shown suggested locations (or “hints”) searched and identified based on the longitude and latitude from the EXIF data. The suggested locations may include establishments that are located at the longitude and latitude (for example, cafes, restaurants, hotels, and other public places including parks, monuments etc.) The method 500 proceeds to block 512, at which stage, the hint generator 256 provides the suggested locations or “hints” for display to the user. The method 500 proceeds to the block 514, at which stage, the user-interface module 258 receives user input indicating the establishment the user is located at. At this point, the user may decide to send the photograph with the location information found to others.

It should be understood that the EXIF data referenced here for identifying the location of an image is used as one example. Data may be obtained from different types of media (e.g., photo, video, audio, etc.) and may include other types of descriptive metadata for identifying particular locations relating to the media that is transmitted from there. In addition, the technology or applications used for taking an image or photograph from a mobile device may transmit the photograph or image with an indication of the location where it was captured, without storing any metadata on the mobile device itself or in the metadata storage location mechanism associated with the image or photograph. Locations associated with photographs or images captured may be transmitted in a myriad ways, depending upon the technology currently used or proposed for this purpose.

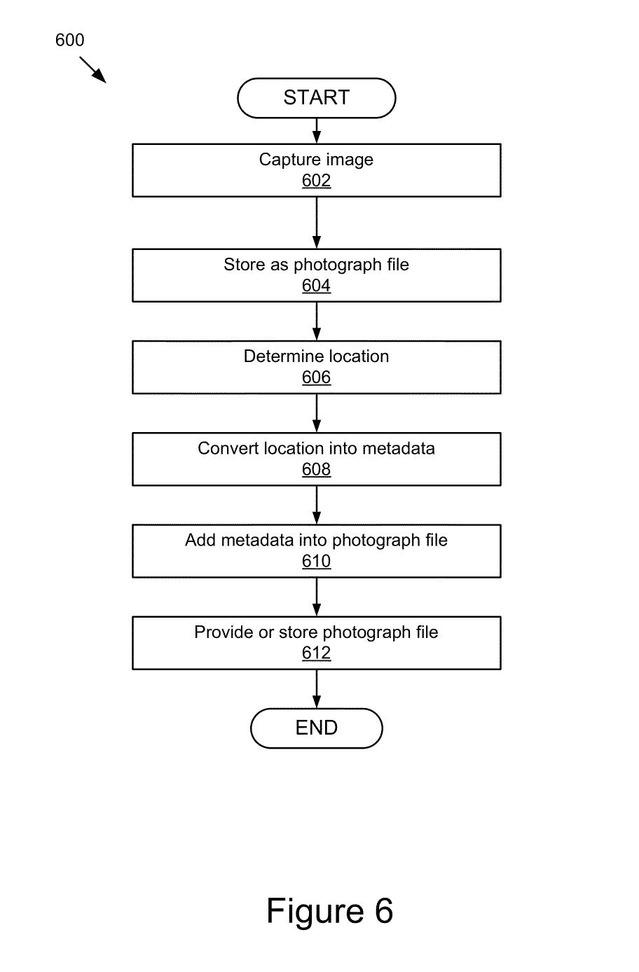

FIG. 6 is a flow chart illustrating an example of a method 600 for adding metadata to a captured photograph. It should be understood that the order of the operations in FIG. 6 is merely by way of example and may be performed in different orders than those that are illustrated and some operations may be excluded, and different combinations of the operations may be performed. The method 600 starts and proceeds to the block 602, at which stage, the user captures an image. The method 600 proceeds to the block 604, at which stage, the photograph-upload detector 252 stores as a photograph file. The method 600 proceeds to the block 606, at which stage, the location-determination module 254 determines the location.

The method 600 proceeds to the block 608, at which stage, the location-determination module 254 converts the location into metadata. The method 600 proceeds to the block 610, at which stage, the system adds metadata into the photograph file. The method 600 proceeds to the block 612, at which stage, the photograph-upload detector 252 provides or stores the photograph file.

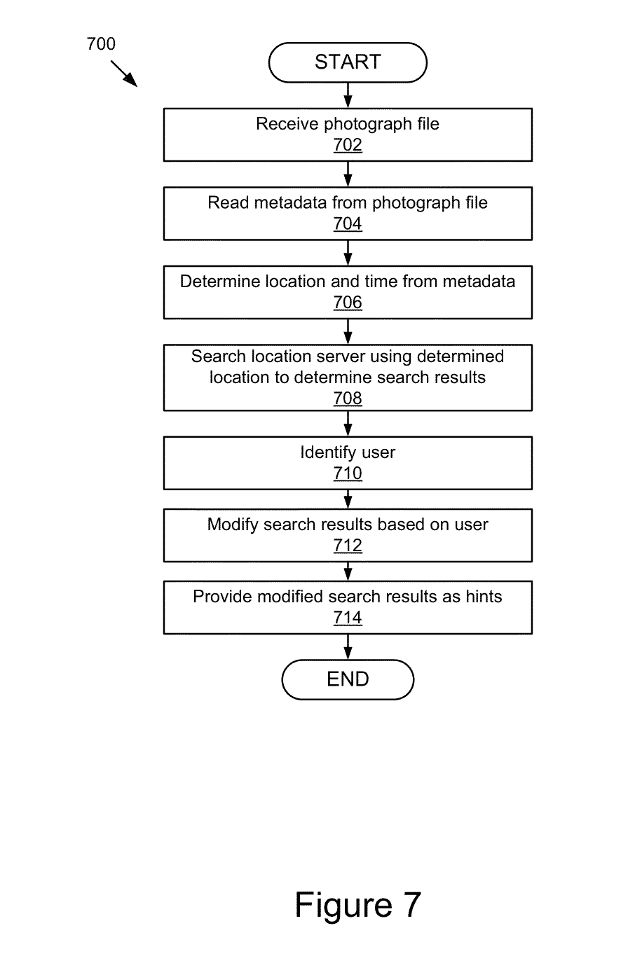

FIG. 7 is a flow chart illustrating an example of a method 700 for determining information from a photograph file. It should be understood that the order of the operations in FIG. 7 is merely by way of example and may be performed in different orders than those that are illustrated and some operations may be excluded, and different combinations of the operations may be performed. The method 700 starts and proceeds to the block 702, at which stage, the photograph-upload detector 252 receives a photograph file. The method 700 proceeds to the block 704, at which stage, the location-determination module 254 reads metadata from the photograph file. The method 700 proceeds to the block 706, at which stage, the location-determination module 254 determines location and time from metadata.

The method 700 proceeds to the block 708, at which stage, the system searches location server using determined location to determine search results. The method 700 proceeds to the block 710, at which stage, the system identifies the user. The method 700 proceeds to the block 712, at which stage, the hint generator 256 modifies search results based on the user. The method 700 proceeds to the block 714, at which stage, the user-interface module 258 provides the modified search results as “hints.”

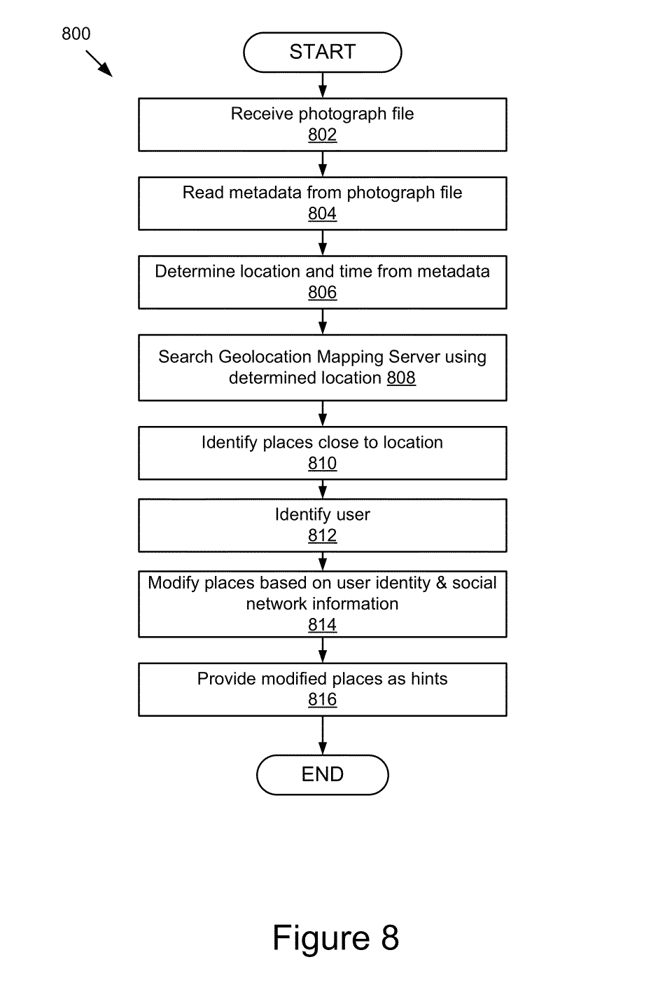

FIG. 8 is a flow chart illustrating an example of a method 800 for determining information from a photograph file and providing “hints”. It should be understood that the order of the operations in FIG. 8 is merely by way of example and may be performed in different orders than those that are illustrated and some operations may be excluded, and different combinations of the operations may be performed. The method 800 starts and proceeds to the block 802, at which stage, the photograph-upload detector 252 receives a photograph file. The method 800 proceeds to the block 804, at which stage, the location-determination module 254 reads metadata from the photograph file. The method 800 proceeds to the block 806, at which stage, the location-determination module 254 determines location and time from the metadata.

The method 800 proceeds to the block 808, at which stage, the system searches a Geo-location-Mapping Server using the determined location. The method 800 proceeds to the block 810, at which stage, the location-determination module 254 identifies places close to the location. The method 800 proceeds to the block 812, at which stage, the system identifies user. The method 800 proceeds to the block 814, at which stage, the system modifies places based on user identity & social network information. The method 800 proceeds to the block 816, at which stage, the user-interface module 258 provides modified places as “hints”.

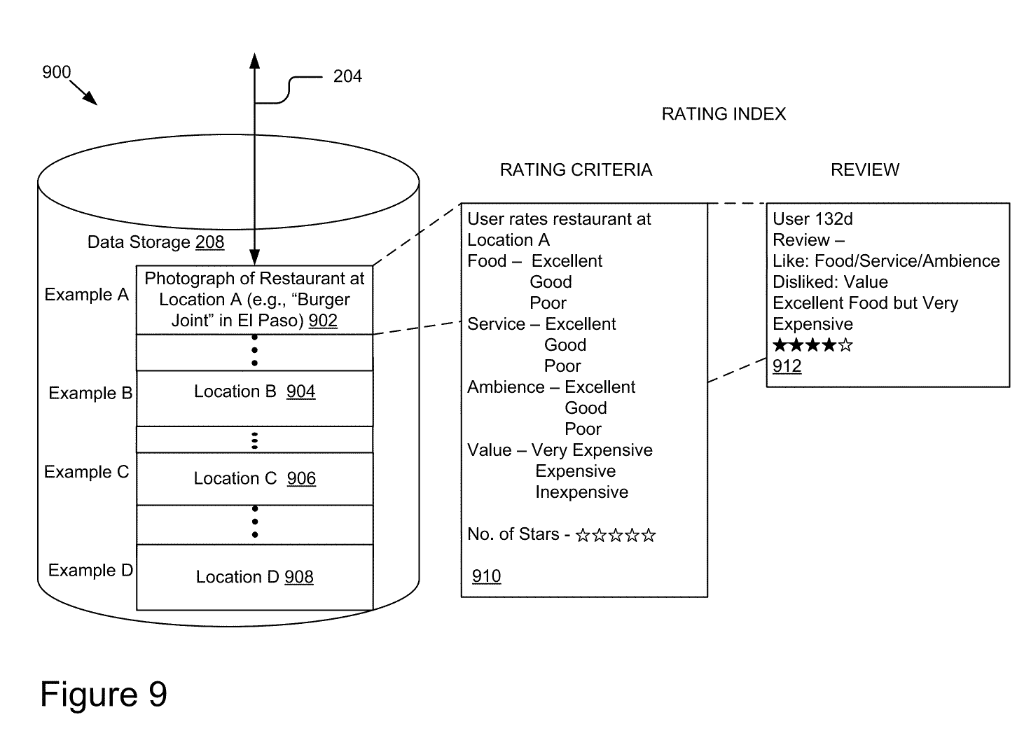

Referring now to FIG. 9, some embodiments of a graphical representation (illustrated by reference numeral 900) of example data storage 208 and example data stored within. In the example illustrated, the data storage includes a photograph of restaurant at location A 902, location B 904 data, location C 906 data, and location D 908 data. For example, the photograph of restaurant at location A 902 includes rating criteria 910 for food (excellent, good, poor), service (excellent, good, poor), ambiance (excellent, good, poor), value (very expensive, expensive, inexpensive), and number of stars. The data may also include a review 912 from user 132d for example “Liked: Food/Service/Ambiance—Disliked: Value—Excellent food but very expensive.”

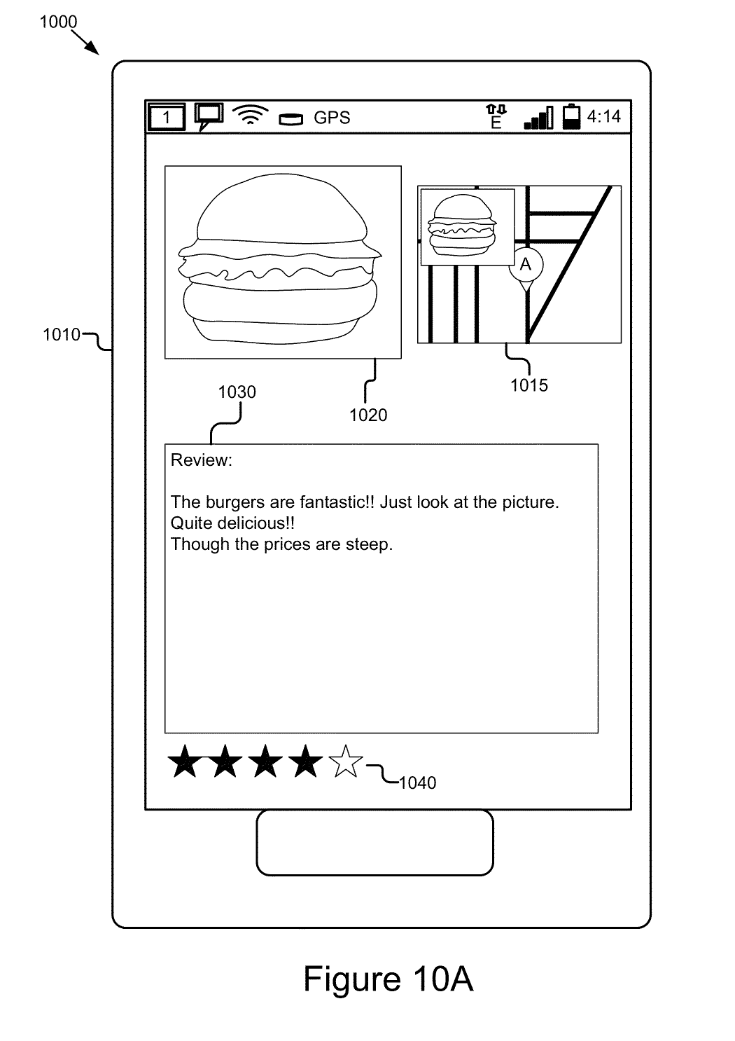

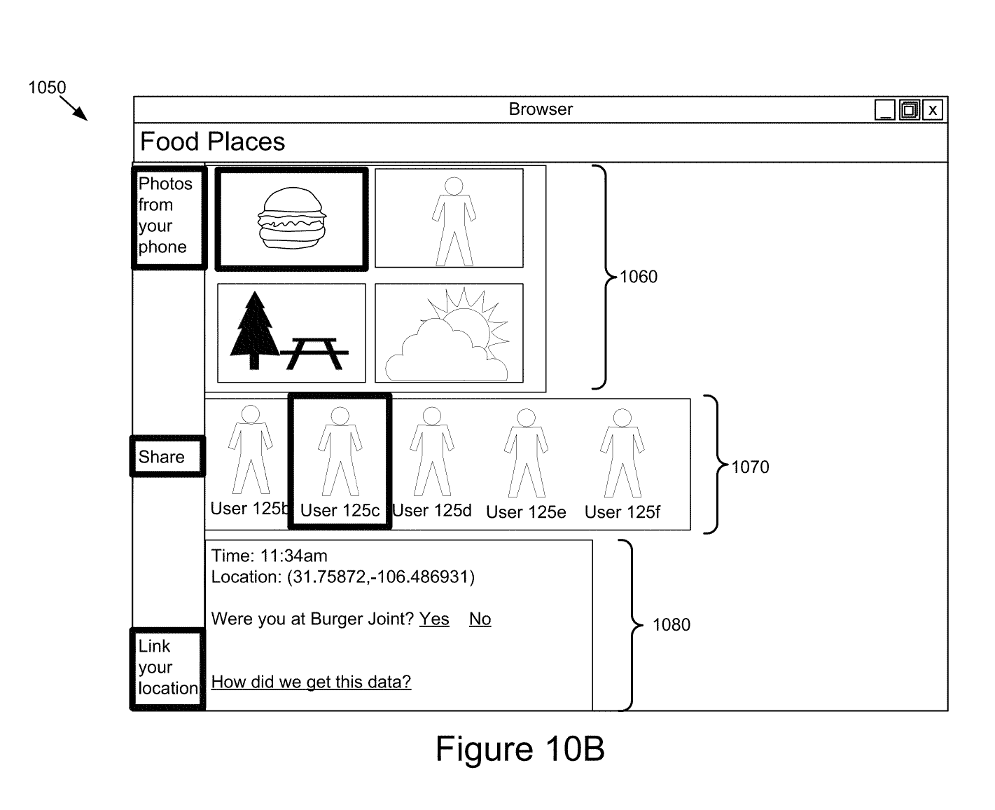

Referring now to FIG. 10A, some embodiments of a graphical representation of a user interface (illustrated by reference numeral 1000) are illustrated. In this example, the user interface includes a mobile device with a display 1010, an image 1020, a map 1015, a review 1030, and a rating 1040. In some implementation the user captures the image 1020 with the user device and uploads the image to an online community. The EXIF data is determined and the location of where the image was captured is received and a map 1015 including the location of the establishment is displayed on the online community. The user may then provide a review of the establishment and a rating (e.g., out of five stars) to describe the quality of the services provided.

Referring now to FIG. 10B, some embodiments of a graphical representation of a user interface (illustrated by reference numeral 1050) are illustrated. In this example, the user interface includes a web browser including a photograph interface 1060, a sharing interface 1070, and a linking interface 1080. In some implementation, the user selects the image using the photograph interface 1060 from the online community, relating to the establishment. The user then selects one or more users, using the sharing interface 1070, in which to share the selected photograph of the establishment. The user may then link to the location of the establishment using the EXIF data obtained from the photograph. The linking interface 1080 may then provide a suggestion to which establishment the user was at based on the EXIF data. The linking interface 1080 may also provide a link to information describing how the system obtained the location information.

In the preceding description, for purposes of explanation, numerous specific details are indicated in order to provide a thorough understanding of the technology described. It should be apparent, however, to one skilled in the art, that this technology can be practiced without these specific details. In other instances, structures and devices are shown in block diagram form in order to avoid obscuring the technology. For example, the present technology is described with some embodiments above with reference to user interfaces and particular hardware. However, the present technology applies to any type of computing device that can receive data and commands, and any devices providing services. Moreover, the present technology is described above primarily in the context of providing support for providing geo-location “hints” with visual content; however, those skilled in the art should understand that the present technology applies to any type of communication and can be used for other applications beyond visual content. In particular, this technology for providing geo-location “hints” with visual content may be used in other contexts besides visual content.

Reference in the specification to “one embodiment,” “an embodiment,” or “some embodiments” means simply that one or more particular features, structures, or characteristics described in connection with the one or more embodiments is included in at least one or more embodiments that are described. The appearances of the phrase “in one embodiment” in various places in the specification are not necessarily all referring to the same embodiment.

Some portions of the detailed descriptions that precede are presented in terms of algorithms and symbolic representations of operations on data bits within a computer memory of either one or more computing devices. These algorithmic descriptions and representations are the means used by those skilled in the data processing arts to most effectively convey the substance of their work to others skilled in the art. An algorithm as indicated here, and generally, is conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the preceding discussion, it should be appreciated that throughout the description, discussions utilizing terms such as “processing,” “computing,” “calculating,” “determining,” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present technology also relates to an apparatus for performing the operations described here. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

This technology can take the form of an entirely hardware embodiment, an entirely software embodiment, or an embodiment including both hardware and software components. In some embodiments, this technology is implemented in software, which includes but is not limited to firmware, resident software, microcode, etc.

Furthermore, this technology can take the form of a computer program product accessible from a computer-usable or computer-readable medium providing program code for use by or in connection with a computer or any instruction execution system. For the purposes of this description, a computer-usable or computer-readable medium may be any apparatus that can include, store, communicate, propagate, or transport the program for use by or in connection with the instruction execution system, apparatus, or device.

A data processing system suitable for storing and/or executing program code includes at least one processor coupled directly or indirectly to memory elements through a system bus. The memory elements may include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Communication units including network adapters may also be coupled to the systems to enable them to couple to other data processing systems, remote printers, or storage devices, through either intervening private or public networks. Modems, cable modems, and Ethernet cards are just a few examples of the currently available types of network adapters.

Finally, the algorithms and displays presented in this application are not inherently related to any particular computer or other apparatus. Various general-purpose systems may be used with programs in accordance with the teachings here, or it may prove convenient to construct more specialized apparatus to perform the required method steps. The required structure for a variety of these systems is outlined in the description above. In addition, the present technology is not described with reference to any particular programming language. It should be understood that a variety of programming languages may be used to implement the technology as described here.

The foregoing description of the embodiments of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. As should be understood by those familiar with the art, the present technology may be embodied in other specific forms, without departing from the spirit or essential characteristics thereof. Likewise, the particular naming and division of the modules, routines, features, attributes, methodologies, and other aspects are not mandatory or significant, and the mechanisms that implement the present disclosure or its features may have different names, divisions and/or formats. Furthermore, as should be apparent to one of ordinary skill in the relevant art, the modules, routines, features, attributes, methodologies and other aspects of the present technology can be implemented as software, hardware, firmware, or any combination of the three. Also, wherever a component, an example of which is a module, of the present technology is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present technology is in no way limited to implementation in any specific programming language, or for any specific operating system or environment. Accordingly, the disclosure of the present technology is intended to be illustrative, but not limiting, of the scope of the present disclosure, which is set forth in the following claims.

What is claimed is:

1. A computer-implemented method, comprising:
receiving, using at least one computing device, captured visual content relating to a point of interest, via a mobile device by a user, from a remote location;
determining, using the computing device, a location of the mobile device via which the user captures the visual content relating to the point of interest;
mapping, using the computing device, the location, to determine geo-location data for the location wherein the geo-location data for the mapping of the location is obtained by receiving location and time data from the visual content;
co-relating, using the computing device, the geo-location data with the visual content;
transmitting, using the computing device, the geo-location data with the visual content, to another electronic device for display;
adding, using the computing device, a user review of the point of interest to the visual content; and
adding, using the computing device, a rating of the point of interest to the visual content.

2. A computer-implemented method, comprising:
receiving, using at least one computing device, captured visual content relating to a point of interest, via a mobile device by a user, from a remote location;
determining, using the computing device, a location of the mobile device via which the user captures the visual content relating to the point of interest;
mapping, using the computing device, the location, to determine geo-location data for the location;
co-relating, using the computing device, the geo-location data with the visual content; and
transmitting, using the computing device, the geo-location data with the visual content, to another electronic device for display.

3. A computer-implemented method according to claim 2, further comprising:
receiving, using the computing device, search results relating to the point of interest.

4. A computer-implemented method according to claim 2, wherein the geo-location data for the mapping of the location is obtained by receiving location and time data from the visual content.

5. A computer-implemented method according to claim 2, further comprising:
receiving, using the computing device, an indication of a web link relating to the point of interest from the mobile device; and
using the link to identify a plurality of suggested locations for the point of interest.

6. A computer-implemented method according to claim 2, wherein the visual content includes a text description.

7. A computer-implemented method according to claim 2, further comprising:
adding, using the computing device, a user review of the point of interest to the visual content.

8. A computer-implemented method according to claim 2, further comprising:
adding, using the computing device, a rating of the point of interest to the visual content.

9. A computer-implemented method according to claim 2, further comprising:
adding, using the computing device, a web link of the location to the visual content.

10. A computer-implemented method according to claim 2, further comprising:
adding, using the computing device, metadata relating to the location to the visual content.

11. A system, comprising:
a processor; and
a memory storing instructions that, when executed, cause the system to:
receive captured visual content relating to a point of interest, via a mobile device by a user, from a remote location;
determine a location of the mobile device via which the user captures the visual content relating to the point of interest;
map the location, to determine geo-location data for the location;
co-relate the geo-location data with the visual content; and
transmit the geo-location data with the visual content, to another electronic device for display.

12. A system according to claim 11, further comprising the memory storing instructions that, when executed, cause the system to:
receive search results relating to the point of interest.

13. A system according to claim 11, wherein the geo-location data for the mapping of the location is obtained by receiving location and time data from the visual content.

14. A system according to claim 11, further comprising the memory storing instructions that, when executed, cause the system to:
receive an indication of a web link relating to the point of interest from the mobile device; and
use the link to identify a plurality of suggested locations for the point of interest.

15. A system according to claim 11, wherein the visual content includes a text description.

16. A system according to claim 11, further comprising the memory storing instructions that, when executed, cause the system to:
add a user review of the point of interest to the visual content.

17. A system according to claim 11, further comprising the memory storing instructions that, when executed, cause the system to:
add a rating of the point of interest to the visual content.

18. A system according to claim 11, further comprising the memory storing instructions that, when executed, cause the system to:
add a web link of the location to the visual content.

19. A system according to claim 11, further comprising the memory storing instructions that, when executed, cause the system to:
add metadata relating to the location to the visual content.
